(19) United States
(12) Patent Application Publication
(10) Pub. No.: US 2010/0024908 A1
(43) Pub. Date: Feb. 4, 2010

(54) Microvolume liquid dispensing device

(76) Inventor: Takashi Yasuda, Kitakyushu-shi (JP)

Correspondence Address: KUBOVCIK & KUBOVCIK, SUITE 1105, 1215 SOUTH CLARK STREET, ARLINGTON, VA, 22202, US

(21) Appl. No.: 12/458,789

(22) Filed: Jul. 22, 2009

Related U.S. Application Data
(63) Continuation-in-part of application No. 12/312,754.

(30) Foreign Application Priority Data
Nov. 27, 2006 (JP) 2006-318948

(51) Int. Cl. F15D 1/02

(52) U.S. Cl. 137/833

(57) ABSTRACT

A microvolume liquid dispensing device capable of automatically dispensing a predetermined volume of a microvolume liquid has been provided. Because one surface of a main channel (13) is gradually varied from a hydrophobic property to a hydrophilic property, a microvolume liquid (A) placed in the main channel (13) can be automatically transported. One surface of a side channel (14) is of a hydrophilic property, so that a potion of the microvolume liquid (A) can be automatically guided to the side channel (14).

This application is a continuation-in-part of application Ser. No. 12/312,754, filed May 26, 2009, which is a 371 of International Patent Application No. PCT/JP2007/072868, filed Nov. 27, 2007, which claims priority based on Japanese Patent Application No. 2006-318948, filed Nov. 27, 2006, which are incorporated herein by reference.

### TECHNICAL FIELD

The present invention belongs to the technical field of microvolume liquid handling on a microfluidic device, and in particular, relates to an art of measuring and mixing a specific amount of a microvolume liquid in a simple and easy way.

### BACKGROUND ART

In the drug discovery field, a compound that could be a new drug is searched comprehensively from hundreds of thousands to millions of kinds of new drug candidate compounds. Thereafter, operations of changing the concentration of the compound into various values and deriving an appropriate concentration are carried out. In the conventional art an automatic liquid dispensing device is used, and an operation of dispensing a liquid which contains a new drug candidate compound on a micro plate by using a multichannel pipette is carried out. In this method, enormous costs are required since a large amount of an expensive agent is used and the device itself is large and expensive. Consequently, an art of microminiaturizing such an automatic liquid dispensing device has recently been developed. If the microminiaturization is realized, an amount of an agent used is significantly reduced and the entire device becomes compact and inexpensive. As a result, costs required for drug discovery can remarkably be reduced.

On the other hand, research and development of fabricating a microchannel on a substrate such as of silicon and glass and performing a variety of analyses with the use of the micro space has actively been carried out recently. This has received attention as an art capable of promoting speedups in analyses, reductions in amounts of reagents used and waste liquids, on-site analyzation, integration of different kinds of analyses, etc. Inventions as described in Patent Documents 1 to 4, for example, have succeeded in measuring a liquid in a channel having a specific volume and generating a droplet, or preparing liquid mixtures having various mixing ratios. Those inventions are considered applicable to the aforementioned drug discovery field.

Patent Document 1: Japanese Published Unexamined Patent Application No. 2002-357616

Patent Document 2: Japanese Published Unexamined Patent Application No. 2004-157097

Patent Document 3: Japanese Published Unexamined Patent Application No. 2005-114430

Patent Document 4: Japanese Patent No. 3749991

### DISCLOSURE OF THE INVENTION

### Problems to be Solved by the Invention

In the inventions as described in Patent Documents 1 to 4, however, the channel of the device and its peripheral equipment need to be connected by a tube for pressure operation of the microvolume liquid when a development test of a new drug is carried out. Therefore, the operation in use is complicated, and also a large amount of the reagent remaining in the tube, etc., is wasted.

An object of the present invention is to provide a microvolume liquid dispensing device capable of automatically sampling a predetermined amount of a microvolume liquid having been injected from the outside.

Another object of the present invention is to provide a microvolume liquid dispensing device capable of transporting a microvolume liquid to the downstream of a side channel by voltage application.

Still another object of the present invention is to provide a microvolume liquid dispensing device capable of mixing a plurality of microvolume liquids by voltage application.

Still another object of the present invention is to provide a microvolume liquid dispensing device capable of mixing different kinds of microvolume liquids at different mixing ratios.

Still another object of the present invention is to provide a microvolume liquid dispensing device which easily guides a microvolume liquid being transported in a main channel into a side channel.

Still another object of the present invention is to provide a microvolume liquid dispensing device capable of easily taking out a microvolume liquid in a side channel to the outside.

### Means for Solving the Problems

The invention as set forth in claim 1 is a microvolume liquid dispensing device comprising a substrate, a main channel formed on an upper surface of the substrate and extending linearly, and one or a plurality of side channels branched off from midway of the main channel and extending linearly, wherein an upper surface of the substrate constituting the main channel is composed of a hydrophilic surface and a hydrophobic surface, and a value obtained by dividing an area of the hydrophilic surface by that of the hydrophobic surface is continuously increased from upstream toward downstream thereof, thereby transporting a microvolume liquid, and an upper surface of the substrate constituting the side channel is made hydrophilic, and a part of the microvolume liquid is guided to the side channel while the microvolume liquid is being transported in the main channel, thereby a predetermined amount of the microvolume liquid is sampled.

Surface tension is such a force that a surface of a liquid or solid attempts to constrict itself and minimize its own area. When a microvolume liquid (a droplet) is placed on a solid surface, three of liquid surface tension, solid surface tension and interfacial tension acting upon an interface between a liquid and a solid are balanced, whereupon the liquid surface and the solid surface form a specific angle. Generally, a hydrophilic solid surface likely to conform to a liquid possesses a large surface tension. When placed on the solid surface, a liquid is pulled by the large surface tension of the solid surface and spread out. On the other hand, a hydrophobic solid surface difficult to conform to a liquid possesses a small surface tension. When placed on the solid surface, a liquid is not spread out and becomes hemispheric since the pulling force of the solid surface is small.

Taking advantage of those properties, at least one surface of the main channel is composed of a hydrophilic surface and a hydrophobic surface, and thereafter is formed on the substrate. The main channel is provided with a droplet transportation means transporting a microvolume liquid in one direction. More specifically, the one surface is configured by providing a surface high in hydrophobic property at the upstream of the main channel and a surface high in hydrophilic property at the downstream of the main channel on the substrate. For example, the one surface is formed by combining hydrophobic surfaces and hydrophilic surfaces of a triangular pattern alternately. It is formed in such a manner that a value obtained by dividing an area of the hydrophilic surfaces of the triangular pattern by an area of the hydrophobic surfaces of the triangular pattern is continuously increased from upstream toward downstream.

Further, when the microvolume liquid being transported in the main channel reaches a branch portion with the side channel, a part thereof is guided to the side channel by a capillary force and then sampled. This is due to the following reasons; the main channel is composed of a surface including a hydrophilic surface and a hydrophobic surface and a surface of a hydrophobic surface only. Both surfaces are more difficult to conform to a microvolume liquid than a surface of a hydrophilic surface only. Therefore, if a side channel having at least one surface of a hydrophilic surface only is provided midway of the main channel, a part of the microvolume liquid enters the side channel which is more likely to conform to a liquid by a capillary force when the microvolume liquid approaches an entrance of the side channel in the middle of traveling in the main channel. At that moment, the microvolume liquid traveling in the main channel has a certain speed, so that a predetermined amount of the microvolume liquid determined by a volume of the side channel enters the side channel, and then the microvolume liquid having entered the side channel and the microvolume liquid continuing to travel in the main channel are completely separated.

As a result, from a microvolume liquid having been injected form the outside, the predetermined amount of a microvolume liquid can automatically be sampled without connecting the device channel and its peripheral equipment by a tube and manipulating the microvolume liquid pneumatically as in the conventional manner.

A plurality of main channels may be provided. Alternatively, a plurality of main channels may be integrated into one main channel midway. Alternatively, one main channel may be branched into a plurality of main channels midway. A cross-sectional shape of the main channel and side channel is optional. For example, a polygonal shape including a rectangular shape and a trapezoidal shape, a circular shape, an elliptical shape, a semicircular shape, etc., can be adopted. The number of side channels to be formed is optional. It may be one, and may be two or three or more. The ratio of a cross-sectional area of the side channel relative to the main channel is optional. For example, letting a cross-sectional area of the main channel be 1, a cross-sectional area of the side channel is 0.01 to 0.5. Note that a capillary force of the side channel will become large if the side channel has a cross-sectional area orthogonal to the longitudinal direction smaller than the main channel.

The side channel may be formed on one of the side walls of the main channel, or may be formed on both side walls. When a plurality of side channels are formed, a formation interval of the side channels in the longitudinal direction of the main channel is optional. For example, they may be formed at a constant pitch or at any interval.

A raw material for the hydrophobic surface constituting at least one surface, for example, the bottom surface (the forming wall of the bottom surface) of the main channel is optional. A raw material for the hydrophilic surface (as well as a raw material for the hydrophilic surface of the side channel) is also optional. The hydrophobic surface may be formed with fluorinated polymers, for example, a polymer obtained by diluting a cyclized perfluoro polymer (CPFP) with a perfluoro solvent (trade name: Cytop CTL-809M of ASAHI GLASS CO., LTD.). Alternatively, a self-assembled monolayer having a hydrophobic functional group, for example, 1-octadecanethiol may be formed on a patterned gold surface by dipping. Alternatively, a plastic surface possessing hydrophobic property such as a cycloolefin polymer may be used. The hydrophilic surface may be formed with SiO2 (silicon dioxide), or a glass substrate surface may be used. Fluorinated polymers, gold and SiO2 are formed on a surface of a silicon substrate, glass substrate, plastic substrate, etc., by semiconductor process such as photolithography.

A material for the substrate and is optional, for example, plastic, silicon, glass, etc. As a plastic, a cycloolefin polymer, polystyrene, polymethyl methacrylate, polycarbonate, etc., can be adopted, for example.

A shape of the substrate in a plan view is optional. For example, it may be a triangle, a polygon of a tetragon or more, a circle, an ellipsis, etc., in a plan view. Further, the substrate may be a flat plate having a constant thickness or a plate having partially different thicknesses.

A forming method of the main channel and side channel on the substrate is optional. The channel can be formed by etching of a silicon substrate or glass substrate, injection molding with plastic, nano-imprinting on a glass substrate or plastic substrate, etc., for example. Moreover, a channel wall may be formed on a silicon substrate or glass substrate with a resist material or silicone resin material to provide the channel. Nano-imprinting is a technique of pressing a stamper having been applied with a minute concavo-convex pattern against a resin thin film or film (bulk) transferred material, thereupon transferring the pattern of the stamper.

As the microvolume liquid, a liquid containing ions such as electrolytic solution (for example, KCl), physiological saline, culture solution, etc., and a liquid including no ions such as ultrapure water can be adopted.

The invention as set forth in claim 2 is the microvolume liquid dispensing device according to claim 1, wherein the substrate possesses electrical insulation, the upper surface of the substrate constituting the side channel is provided with a first electrode and a second electrode in this order toward downstream thereof being spaced apart, a surface of the second electrode is hydrophobic, a microvolume liquid having been dammed at the second electrode having the hydrophobic surface is transported downstream of the side channel by applying a voltage between both electrodes.

According to the invention as set forth in claim 2, a microvolume liquid having been guided to the side channel by a capillary force passes through the first electrode and is dammed at (an end of) the second electrode provided downstream of the first electrode. This is because a surface of the second electrode contacting with the microvolume liquid is hydrophobic. At that moment, the microvolume liquid contacts with the second electrode at a front end portion thereof, and contacts with the first electrode in such a manner as straddling the electrode. When a voltage is applied to both electrodes provided in the channel, the second electrode with which the microvolume liquid contacts at the front end portion thereof attracts the microvolume liquid, so that a contact angle of the microvolume liquid becomes small. That is, apparent surface wettability of the second electrode turns from hydrophobic property to hydrophilic property. As a result, the microvolume liquid gets on the surface of the second electrode and gets over the second electrode eventually, and a specific amount of the microvolume liquid can be transported further in the side channel. At this moment, a force for carrying the liquid further in the side channel is a capillary force. Accordingly, if configured to make a side channel width at the downstream side of the second electrode smaller than that of the upstream side, the liquid can be delivered without fail.

Further, it becomes possible to start transporting the microvolume liquid at the time of voltage application. Furthermore, it becomes possible to adjust timing of mixing with another microvolume liquid on the device and to start transporting a plurality of microvolume liquids simultaneously.

The substrate is optional as long as they are electrically insulating materials. Note that, when a silicon substrate which is an electrically non-insulating body is used, an insulating film such as SiO2 needs to be formed on the surface in order to form an electrode on the substrate.

A material for the first electrode and the second electrode is optional. Gold, aluminum and copper are used, for example. Among them, gold is easily formed into a film by vacuum evaporation and patterned by a lift-off method. When gold is used, however, adhesiveness with the substrate is poor. Therefore, if a chromium thin film is sandwiched between the gold thin film electrode and the substrate, adhesiveness between the gold thin film electrode and the substrate will be enhanced. A method for achieving hydrophobic property on the surface of the second electrode is optional. Since a gold surface just after the film formation exhibits hydrophobic property, the surface may be used as it is. However, the hydrophobic property is lowered with time, and accordingly it is better to form a hydrophobic thin film on the surface. Conceivable methods include, for example, coating the surface with a fluorinated polymer such as Cytop manufactured by ASAHI GLASS CO., LTD., and forming a self-assembled monolayer having a hydrophobic functional group such as 1-octadecanethiol.

Both electrodes as described above may be with irregularities or inclination. However, a flat thin film electrode is preferred.

A film thickness of both electrodes is, for example, 0.3 μm. If too thick, irregularities on the device become too large, and the traveling of the microvolume liquid can be interrupted. If too thin, a resistance of both electrodes becomes large, and rising of an applied voltage can be slow or a driving voltage can be increased by a voltage drop of the electrode itself.

It is also possible to transport an electrically insulating microvolume liquid such as ultrapure water by coating the surface of the second electrode with a hydrophobic dielectric film. In that case, a raw material for the dielectric film is optional. For example, SiO2, PTFE (Polytetrafluoroethylene), parylene or barium strontium titanate is used. A material higher in relative permittivity could make a required driving voltage smaller. A film thickness of the dielectric film is, for example, 0.1 to 2 μm. Although the microvolume liquid can be transported at lower voltage if the dielectric film is thinner, there is a possibility of electrolyzing the microvolume liquid when a voltage required for the transportation is applied. If the dielectric film is thickened, there is no concern of electrolyzing the microvolume liquid, but a voltage required for the transportation is increased. Therefore, for the thickness of a dielectric film, there exists such an appropriate value that does not electrolyze the microvolume liquid and is capable of transporting it at a voltage as low as possible. Further, if the dielectric film is thickened, irregularities on the device become large and thus there is a possibility that traveling of the microvolume liquid is interrupted.

The invention as set forth in claim 3 is the microvolume liquid dispensing device according to either claim 1 or claim 2, wherein a plurality of the main channels are arranged spaced apart, respective downstream ends of the side channels provided to the main channels adjacent to each other are connected with each other, the second electrode is arranged at a connecting portion at the downstream end of each side channel or slightly upstream of the connecting portion of the side channel, and different microvolume liquids are transported on respective main channels, a portion of each microvolume liquid is sampled in the corresponding side channel during transportation, and then the respective sampled different microvolume liquids are mixed by voltage application between both electrodes.

According to the invention as set forth in claim 3, when different microvolume liquids are transported in respective main channels and reach the side channel, a portion of each microvolume liquid is sampled in the side channel since at least one surface of the side channel is hydrophilic. At this time, the second electrode having a hydrophobic surface is provided at a downstream portion of each side channel. Thus, respective side channels of the main channels adjacent to each other are connected with each other but the different microvolume liquids within respective side channels are separated. After that, a voltage is applied between both electrodes, whereupon the respective sampled different microvolume liquids are attracted to the second electrode with a contact angle thereof smaller. As a result, those different microvolume liquids can be mixed.

The number of main channels may be two (two main channels are arranged in parallel) or three (three main channels are arranged in parallel). Further, adjacent main channels may be four or more (four main channels are arranged substantially annularly).

The invention as set forth in claim 4 is the microvolume liquid dispensing device according to any one of the preceding claims, wherein one surface of the substrate is mounted with a cover.

According to the invention as set forth in claim 4, a cover is mounted on one surface of the substrate. Thus, the liquid can be prevented from being evaporated during the transportation thereof. Further, a space having a predetermined cross-sectional area is formed between the side channel surfaces and the cover surface. Thus, a volume of the liquid flowing into the side channel can be determined. More specifically, different microvolume liquids can be mixed at the same mixing ratio or different mixing ratios.

Side channels connected between the adjacent main channels preferably have the same total value in volume. Each volume ratio of respective connected side channels is optional.

Herein, the meaning of being different in volume ratio among the side channels will be described. For example, in the relationship between a plurality of side channels A1, A2 . . . An formed on one of main channels adjacent to each other and a plurality of side channels B1, B2 . . . Bn formed on the other main channel, corresponding side channels (for example, A1-B1, A2-B2 . . . An-Bn) shall be connected with each other. At that moment, a state where a ratio X1 of a volume of the side channel A1 to a volume of the side channel B1, a ratio X2 of a volume of the side channel A2 to a volume of the side channel B2 and a ratio Xn of a volume of the side channel An to a volume of the side channel Bn are different from one another is referred to as “being different in volume ratio among the side channels.”

The invention as set forth in claim 5 is the microvolume liquid dispensing device according to claim 3, wherein a side channel extending from one of the main channels adjacent to each other and a side channel extending from the other forms a pair, and a plurality of micro side channels extending linearly from a side surface of one of the paired side channels are provided to be connected to a side surface of the other side channel.

According to the invention as set forth in claim 5, micro side channels are provided at a side surface of the side channel, whereby a contact area of two kinds of liquids at mixing can be enlarged. Further, a diffusion distance of solute molecules in each microvolume liquid at mixing can be shortened. Consequently, a large amount of liquid mixtures can be produced quickly.

The invention as set forth in claim 6 is the microvolume liquid dispensing device according to claim 5, wherein a cover is mounted at least on a side channel forming portion of the substrate.

According to the invention as set forth in claim 6, the cover is not mounted on the main channel on one surface of the substrate, so that the microvolume liquid on the main channel can easily and reliably be transported by a wettability gradient. Further, a surface of the cover does not need to be hydrophilic. Therefore, a material of plastic having a hydrophobic surface can be used, and a manufacturing process of the device can drastically be simplified.

### EFFECTS OF THE INVENTION

According to the invention as set forth in claim 1 of the present invention, when the microvolume liquid being transported in the main channel reaches a branch portion with the side channel, a specific amount of the microvolume liquid can be sampled (measured) without requiring a tube connection with the outside of the device and only by introducing the microvolume liquid from the outside since at least one surface of the side channel is hydrophilic.

As a result, for example, in the drug discovery field, the amount of a reagent used is reduced more remarkably than ever, and accordingly significant cost reductions can be achieved when an expensive reagent is used. Further, complicated connections between the device and its peripheral equipment other than the electrical connection become unnecessary, and required equipment is remarkably simplified. Therefore, the entire device becomes compact and inexpensive. This also leads to significant cost reductions.

In particular, according to the invention as set forth in claim 2, a first electrode is provided around a connecting portion with the main channel in the side channel or at a position slightly apart from the connecting portion, and a second electrode is provided at a downstream portion in the side channel, thereby allowing the microvolume liquid sampled in the side channel to be transported further on the device by electrical liquid operation.

According to the invention as set forth in claim 3, a plurality of main channels are arranged spaced apart, and respective downstream ends of the side channels provided to the main channels adjacent to each other are connected with each other. Therefore, electrical liquid operation with the use of the aforementioned first electrode and second electrode allows two or more kinds of microvolume liquids to be mixed.

According to the invention as set forth in claim 4, a cover is mounted on one surface of the substrate. Thus, the liquid can be prevented from being evaporated during the transportation thereof. Further, a space having a predetermined cross-sectional area is formed between the side channel surfaces and the cover surface. Thus, a volume of the liquid flowing into the side channel can be determined. More specifically, different microvolume liquids can be mixed at the same mixing ratio or different mixing ratios.

According to the invention as set forth in claim 5, micro side channels are provided at a side surface of the side channel, whereby a contact area of two kinds of liquids at mixing can be enlarged. Further, a diffusion distance of solute molecules in each microvolume liquid at mixing can be shortened. Consequently, a large amount of liquid mixtures can be produced quickly.

According to the invention as set forth in claim 6, the cover is not mounted on the main channel on one surface of the substrate, so that the microvolume liquid on the main channel can easily and reliably be transported by a wettability gradient. Further, a surface of the cover does not need to be hydrophilic. Therefore, a material of plastic having a hydrophobic surface can be used, and a manufacturing process of the device can drastically be simplified.

### BRIEF DESCRIPTION OF THE DRAWINGS

FIG. 1a is a schematic plan view showing a state before sampling microvolume liquid by a microvolume liquid dispensing device according to a first embodiment of the present invention;

FIG. 1b is a schematic plan view showing a state during sampling the microvolume liquid by the microvolume liquid dispensing device according to the first embodiment of the present invention;

FIG. 1c is a schematic plan view showing a state after sampling the microvolume liquid by the microvolume liquid dispensing device according to the first embodiment of the present invention;

FIG. 1d is a schematic plan view showing a state during dispensing the microvolume liquid after the sampling by the microvolume liquid dispensing device according to the first embodiment of the present invention;

FIG. 2 is a longitudinal cross-sectional view orthogonal to a transporting direction of the microvolume liquid of the microvolume liquid dispensing device according to the first embodiment of the present invention;

FIG. 3 is a cross-sectional view taken along the line S3-S3 of FIG. 2;

FIG. 4a is a schematic plan view showing a state before sampling microvolume liquids by a microvolume liquid dispensing device according to a second embodiment of the present invention;

FIG. 4b is a schematic plan view showing a state after sampling the microvolume liquids by the microvolume liquid dispensing device according to the second embodiment;

FIG. 4c is a schematic plan view showing a state during mixing the microvolume liquids after the sampling by the microvolume liquid dispensing device according to the second embodiment of the present invention;

FIG. 5 is a longitudinal cross-sectional view orthogonal to a transporting direction of the microvolume liquids of the microvolume liquid dispensing device according to the second embodiment of the present invention;

FIG. 6a is a schematic perspective view showing a state before sampling microvolume liquids by a microvolume liquid dispensing device according to a third embodiment of the present invention;

FIG. 6b is a schematic perspective view showing a state after sampling the microvolume liquids by the microvolume liquid dispensing device according to the third embodiment of the present invention;

FIG. 6c is a schematic perspective view showing a state during mixing the microvolume liquids after the sampling by the microvolume liquid dispensing device according to the third embodiment of the present invention;

FIG. 6d is a schematic perspective view showing a state after cell seeding into cell culture wells within a biopsy tray which is used being covered with the microvolume liquid dispensing device according to the third embodiment of the present invention;

FIG. 6e is a schematic perspective view showing a state where a biopsy of cells is in operation while the microvolume liquid dispensing device according to the third embodiment of the present invention is placed on the cell culture wells; and

FIG. 6f is a schematic longitudinal cross-sectional view showing a state where the biopsy of cells is in operation while the microvolume liquid dispensing device according to the third embodiment of the present invention is placed on the cell culture wells.

FIG. 7a is a schematic plan view showing a state before sampling microvolume liquids by a microvolume liquid dispensing device according to a fourth embodiment of the present invention;

FIG. 7b is a schematic plan view showing a state after sampling the microvolume liquids by the microvolume liquid dispensing device according to the fourth embodiment of the present invention; and

FIG. 7c is a schematic plan view showing a state during mixing the microvolume liquids after the sampling by the microvolume liquid dispensing device according to the fourth embodiment of the present invention.

### DESCRIPTION OF SYMBOLS

10, 10A, 10B, 10C: Microvolume liquid dispensing device
11: Substrate
12: Cover
13: Main channel
14: Side channel
14a: Micro side channel
14b: Nozzle
15: First electrode
16: Second electrode
20: Micropipette
21: Biopsy tray
22: Cell culture well
23: Culture medium
24: Cell
A, B: Microvolume liquid
a: Hydrophilic surface
b: Hydrophobic surface
c: Hydrophobic thin film

### BEST MODES FOR CARRYING OUT THE INVENTION

Hereinafter, embodiments of the present invention will be described in detail.

### First Embodiment

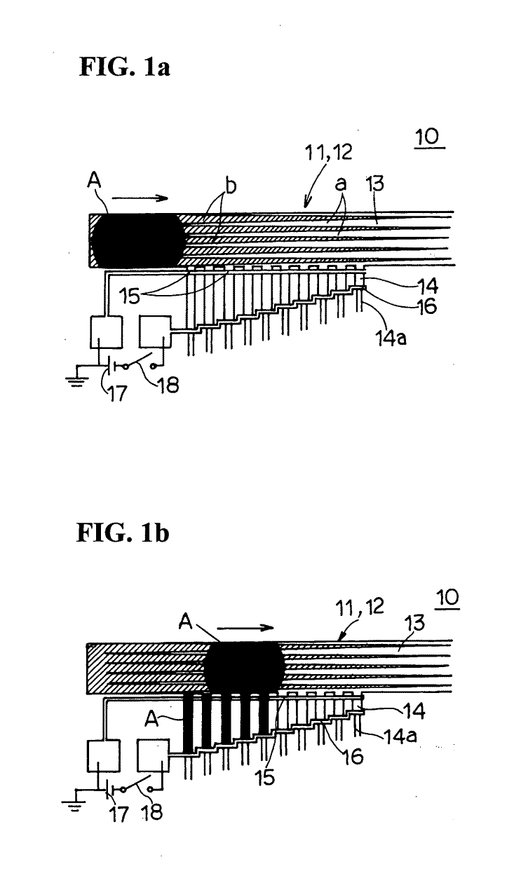

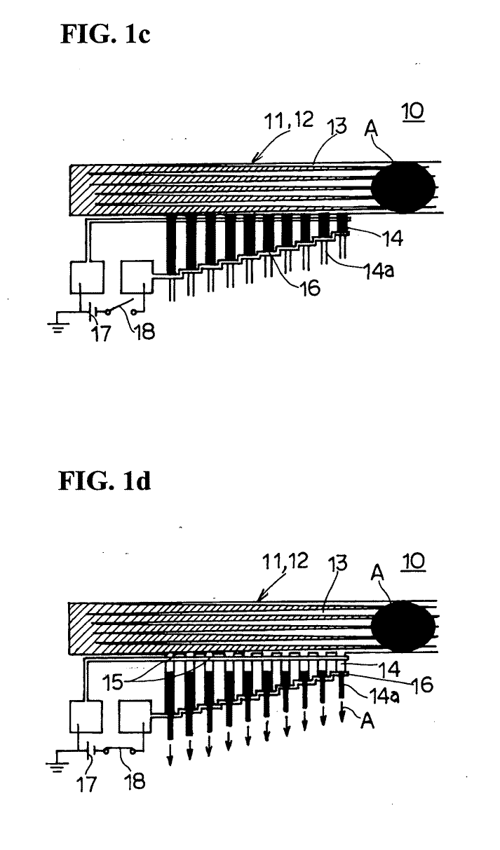

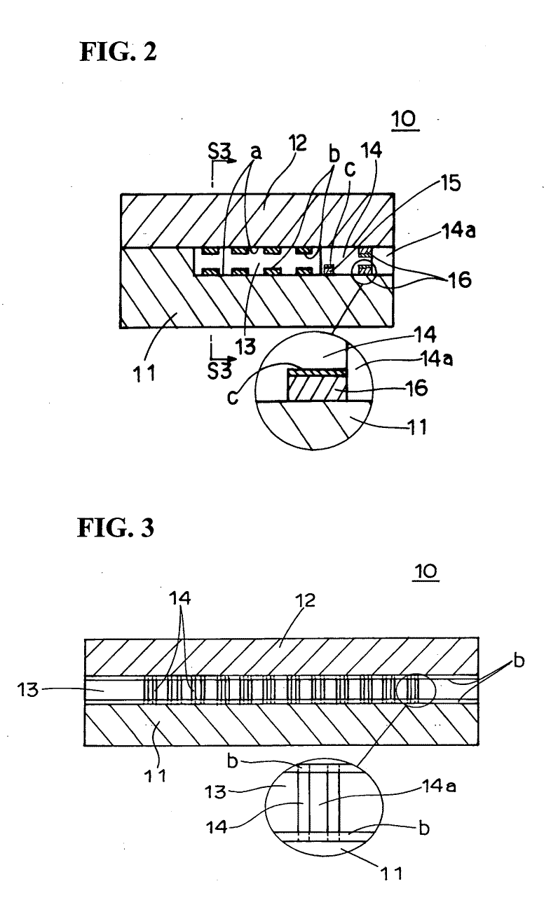

In FIGS. 1 to 3, reference numeral 10 is a microvolume liquid dispensing device according to a first embodiment of the present invention. The microvolume liquid dispensing device 10 includes a substrate 11, a cover 12 mounted on one surface of the substrate 11, a main channel 13 formed between the substrate 11 and the cover 12 and extending in one direction and a side channel 14 formed between the substrate 11 and the cover 12 and branched off from midway of the main channel 13. Hereinafter, those components will be described in detail.

As the substrate 11, adopted is a plastic (a cycloolefin polymer) substrate which is rectangular in a plan view and substantially concave-shaped in cross section. The substrate 11 has one main channel 13 and ten side channels 14. The substrate 11 has an opening side of the concave shape directed upward, and the cover 12 rectangular in a plan view is mounted on the top surface of the substrate 11. A space rectangular in cross section between the concaved substrate 11 and the cover 12 constitutes the main channel 13 where a microvolume liquid A is trasported.

As the cover 12, adopted is a plastic (a cycloolefin polymer) substrate which is rectangular in a plan view. Dimensions of the substrate 11 are 30 mm in length, 30 mm in width and 1 mm in thickness. Dimensions of the cover 12 are 30 mm in length, 30 mm in width and 1 mm in thickness. The main channel 13 is formed over the entire or part length of the substrate 11. Respective side channels 14 are formed at a constant pitch in the longitudinal direction of the substrate 11 while the longitudinal direction thereof is oriented in the width direction of the substrate 11. A width of the main channel 13 is 2 mm and that of the side channel 14 is 500 μm. Micro side channels 14a narrowed up to 100 μm in width are connected with downstream ends of respective side channels 14. Each depth (channel height) of the main channel 13 and the side channels 14 (including the micro side channels 14a) is 25 μm.

On a top surface of the main channel 13 (a main channel portion on an undersurface of the cover 12) and a bottom surface of the main channel 13 (a main channel portion on a top surface of the substrate 11), formed is a wettability gradient surface which is continuously varied in value obtained by dividing an area of a hydrophilic surface “a” by that of a hydrophobic surface “b.” In addition, only either of the bottom surface or top surface of the main channel 13 may be made into the wettability gradient surface.

The hydrophobic surface is formed of a triangular pattern having a base of 50 μm to 500 μm and a height of 10 mm to 20 mm. Similarly, the hydrophilic surface is formed of a triangular pattern having a base of 50 μm to 500 μm and a height of 10 mm to 20 mm. Those triangular patterns are combined so as to alternate the hydrophilic surface “a” and the hydrophobic surface “b.” As shown in FIG. 1a, an upstream of the channel is formed so as to have a surface where an area of the hydrophobic surface “b” is larger than that of the hydrophilic surface “a,” and a downstream of the channel is formed so as to have a surface where an area of the hydrophilic surface “a” is larger than that of the hydrophobic surface “b.”

More specifically, the formation of the triangular patterns is carried out in such a manner that a value obtained by dividing an area of the hydrophilic surface “a” by that of the hydrophobic surface “b” is continuously increased from upstream toward downstream. As a material of the hydrophobic surface “b,” adopted is 1-octadecanethiol which is formed on a gold pattern. As a material of the hydrophilic surface “a,” adopted is SiO2 (0.2 μm in thickness) formed on a plastic surface by sputtering. In addition, the microvolume liquid A being transported in the main channel 13 is guided to the side channel 14 with ease if a side portion at the side channel 14 on one surface of the main channel 13 is made into a hydrophilic surface. A pattern forming the hydrophilic surface “a” and the hydrophobic surface “b” is not restricted to the triangular pattern. For example, it may be configured such that sides except the base of the triangle are curved and a rate of change of the value obtained by dividing an area of the hydrophilic surface “a” by that of the hydrophobic surface “b” is non-linearly increased from upstream toward downstream.

On a top surface of the side channel 14 (a side channel portion on an undersurface of the cover 12) and a bottom surface of the side channel 14 (a side channel portion on a top surface of the substrate 11), formed is a hydrophilic surface “a.”

Further, in the vicinity of a side channel entrance portion (a branch portion) of only either one of the substrate 11 or the cover 12, serially formed is a first electrode 15 of gold over the entire width of each side channel 14. Further, at an end of the downstream side of the side channel 14 of both the substrate 11 and the cover 12, serially formed is a second electrode 16 of gold over the entire width of each side channel 14. On a surface of the first electrode 15 and second electrode 16, a thin film “c” of 1-octadecanethiol exhibiting hydrophobic property is formed.

The surface of the first electrode 15 is hydrophobic but a surface of the side channel opposed thereto is hydrophilic. Thus, the microvolume liquid A having been guided to the side channel cannot stay on the first electrode 15.

The surface of the second electrode 16 is hydrophobic and is formed on all inner wall surfaces constituting the side channel. Thus, the microvolume liquid A having been guided to the side channel is dammed on an end surface of the upstream side of the second electrode 16. As a result, the microvolume liquid A determined by a volume sandwiched between the side channel entrance and the end of the second electrode 16 is measured. The microvolume liquid A is an electrolytic solution containing ions. Each first electrode 15 is electrically connected by a wire and each second electrode 16 is electrically connected by another wire. They constitute an electric circuit with a power source (approximately 3V) 17 and a switch 18 arranged midway.

Hereinafter, a manufacturing method of the substrate 11 will be described. First, the substrate 11 having a main channel 13 and side channels 14 of 25 μm in depth is injection-molded with a cycloolefin polymer. Subsequently, an SiO2 thin film is formed on a bottom surface of all of the channels by a sputtering method and a lift-off method. More specifically, a resist is left on the entire surface except the channel by negative resist application, ultraviolet exposure and development. An opening portion is provided only on a bottom surface portion of the channel, and on the entire surface thereof, an SiO2 thin film is formed by a sputtering method. Then, the SiO2 thin film on the resist is removed by resist removal with acetone. As a result, the SiO2 thin film can be formed only on the bottom surface of the channel.

After that, a gold thin film triangular pattern is formed on the SiO2 thin film of the main channel 13 by a vacuum evaporation method and a lift-off method. At the same time, gold thin films of the electrode 15 and electrode 16 are patterned so as to cross the side channels 14. More specifically, the following operation is performed. A resist is left on the entire surface except places where the triangular pattern and both electrodes are formed, by negative resist application, ultraviolet exposure and development, and opening portions are provided only at the places where the triangular pattern and both electrodes are formed. On the entire surface thereof, a gold thin film is formed by a vacuum evaporation method, and then the gold thin film on the resist is removed by resist removal with acetone. As a result, the gold thin film triangular pattern on the main channel 13 and the electrode 15 and electrode 16 crossing the side channels 14 can be formed.

1-octadecanethiol is formed on the gold thin film as a hydrophobic surface “b” by a dipping method, whereby the SiO2 thin film having been exposed on the bottom surface of the main channel 13 acts as a hydrophilic surface “a.” By this way, the substrate 11 formed with a concaved structure in cross section and having the electrodes 15 and 16 is manufactured.

On the other hand, on the plastic substrate of the cover 12, an SiO2 thin film is formed at a place corresponding to a top surface of all of the channels by a sputtering method and a lift-off method. After that, a gold thin film triangular pattern is formed on the SiO2 thin film corresponding to the main channel 13 by a vacuum evaporation method and a lift-off method. At the same time, a gold thin film for the electrode 16 is patterned so as to cross a place corresponding to the side channel 14. At that moment, attention is required to not form a gold thin film for the electrode 15. Subsequently, a monolayer of 1-octadecanethiol is self-assemblingly formed on the gold thin film by a dipping method. The substrate 11 and cover 12 thus obtained are adhered to each other by thermal compression bonding.

Now, usage of the microvolume liquid dispensing device 10 according to the first embodiment of the present invention will be described with reference to FIGS. 1a to 1d.

0.1 to 10 μL of a microvolume liquid A is measured by a general-purpose dispenser, and the microvolume liquid A is introduced from the upstream of the main channel 13 into the device (FIG. 1a). The top surface and bottom surface of the main channel 13 continuously change from upstream toward downstream in wettability from a surface high in hydrophobic property to a surface high in hydrophilic property. Therefore, the microvolume liquid A automatically starts its travel within the main channel 13. Here, if the side surface of the main channel 13 is hydrophilic, the microvolume liquid A tries to stay on the surface. Therefore, smooth liquid delivery becomes difficult. However, the plastic substrate surface exhibiting hydrophobic property is adopted as a material for the side surface of the channel, and accordingly such a problem does not arise.

While the microvolume liquid A travels in the main channel 13, a part of the microvolume liquid A is guided to each side channel 14 by a capillary force (FIG. 1b). The guided microvolume liquid A is dammed at an end of the second electrode 16 close to the outlet of each side channel 14. The microvolume liquid A which has not been guided to the side channels 14 continues traveling downstream of the main channel 13. As a result, a specific amount of the microvolume liquid A determined by a volume sandwiched between a side channel entrance and the second electrode 16 is measured out (FIG. 1c). Herein, there are constructed ten side channels 14 with volumes decreased toward the downstream at a specific ratio, whereby ten pieces of the microvolume liquid A different in liquid amount can be sampled (measured).

Subsequently, the switch 18 is turned on to apply a voltage of approximately 3V between the first electrode 15 and the second electrode 16 provided in each side channel 14. By this, the electrode 16 contacting with the front end of the microvolume liquid A attracts the microvolume liquid A, so that a contact angle of the microvolume liquid A becomes small. That is, apparent surface wettability of the electrode 16 turns from hydrophobic property to hydrophilic property. Thus, the microvolume liquid A gets on the surface of the second electrode 16 and gets over the second electrode 16 eventually. A specific amount of the microvolume liquid A is further transported in the side channel 14 (FIG. 1d). Since a micro side channel 14a smaller than the side channel 14 in cross sectional area is connected with the downstream side of the second electrode 16, the capillary force for carrying the microvolume liquid A downstream is larger than the side channel 14, and accordingly the microvolume liquid A is delivered without fail.

As above, when the microvolume liquid A being transported in the main channel 13 reaches a branch portion with each side channel 14, a specific amount of the microvolume liquid A can be sampled without requiring a tube connection with the outside of the device and only by introducing the microvolume liquid A from the outside, since at least one surface of each side channel 14 is hydrophilic. As a result, in the drug discovery field, for example, an amount of a reagent used is reduced more remarkably than ever, and accordingly significant cost reductions can be promoted when an expensive reagent is used. Furthermore, complicated connections between the device and its peripheral equipment other than the electric connection become unnecessary, and required peripheral equipment is remarkably simplified. As a result, the entire device becomes compact and inexpensive. This also leads to significant cost reductions.

Further, the other surface as well as one surface of the main channel 13 is also composed of a hydrophilic surface “a” and a hydrophobic surface “b,” and a value obtained by dividing an area of the hydrophilic surface “a” by that of the hydrophobic surface “b” is configured to be increased continuously from upstream toward downstream of the other surface. Therefore, transportability of the microvolume liquid A in the main channel 13 is enhanced.

### Second embodiment

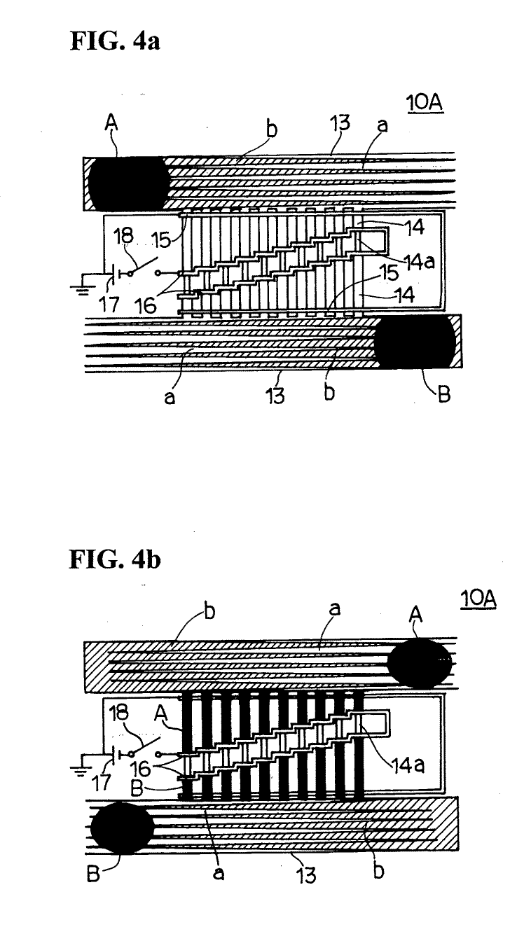

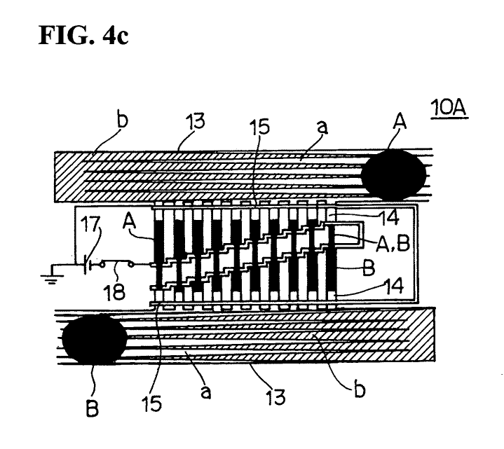

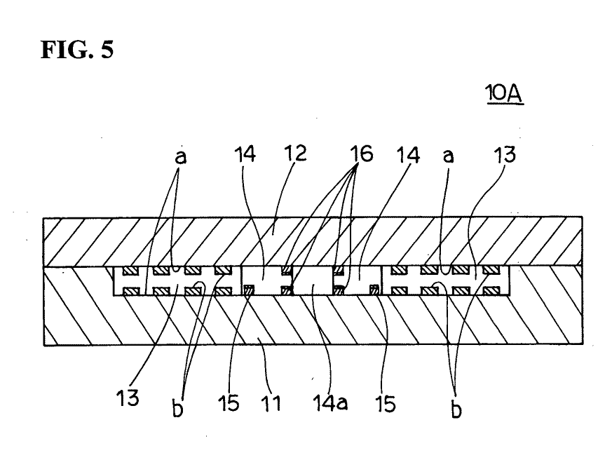

Next, a microvolume liquid dispensing device 10A according to a second embodiment of the present invention will be described with reference to FIG. 4 and FIG. 5.

As shown in FIG. 4 and FIG. 5, the microvolume liquid dispensing device 10A of the second embodiment is such that two main channels 13 are arranged in parallel with each other being spaced apart, downstream ends of respective ten side channels 14 of the adjacent main channels 13 are connected with each other by micro side channels 14a, a second electrode 16 is arranged at a connecting portion at a downstream end of each side channel 14, different microvolume liquids A and B are transported in the main channels 13, a portion of each microvolume liquid A, B is sampled in each side channel 14 during the transportation, and then the sampled different microvolume liquids A and B are mixed by voltage application between a corresponding first electrode 15 and second electrode 16. The microvolume liquid A is the above-mentioned electrolytic solution containing ions while the microvolume liquid B is another electrolytic solution containing ions.

In this case, the two main channels 13 have the same shape, and the side channels 14 connected with each other between both main channels 13 are all configured to have the same total value in volume but are different in volume ratio. More specifically, transporting directions of the microvolume liquids A and B in both main channels 13 are opposed. Thus, to a side channel 14 having the largest volume of one of the main channels 13, a side channel 14 having the smallest volume of the other main channel 13 is connected. A side channel 14 having the second largest volume of the one main channel 13 and a side channel 14 having the second smallest volume of the other main channel 13 are connected in sequence. The first electrode 15 of each side channel 14 of both main channels 13 is electrically connected by a wire. The second electrode 16 of each side channel 14 of both main channels 13 is electrically connected by another wire.

Next, usage of the microvolume liquid dispensing device 10A according to the second embodiment of the present invention will be described with reference to FIGS. 4a to 4c.

0.1 to 10 μL of a microvolume liquid A and a microvolume liquid B are measured by a general-purpose dispenser and introduced from the upstream of the two main channels 13 (FIG. 4a). The microvolume liquids A and B automatically travel toward the downstream in the main channels 13 due to a wettability gradient, and a part thereof is guided to the side channel 14 midway. The guided liquid is dammed at an end of the second electrode 16 close to the outlet of the side channel 14, and specific amounts of the microvolume liquids A and B are measured out (FIG. 4b). Subsequently, a voltage is applied to both electrodes 15 and 16 provided in the side channel 14. Then, the measured microvolume liquids A and B within the side channels 14 get over the second electrodes 16, come in contact with each other and are mixed eventually (FIG. 4c). Changing the length of a plurality of side channels 14 allows for mixing at various mixing ratios. Further, since volumes of the liquids A and B are significantly small, the mixing progresses rapidly and a time required is remarkably short.

Since the microvolume liquid dispensing device 10A of the second embodiment is configured as above, different microvolume liquids A and B are sampled in corresponding side channels 14 during transporting the microvolume liquids A and B in the main channels 13, and then each sampled different microvolume liquid A, B can be mixed in respective side channels 14 by voltage application to both electrodes 15 and 16. Moreover, in the second embodiment, the side channels 14 connected with each other between both main channels 13 are all configured to have the same total value in volume but are different in volume ratio, so that the respective sampled microvolume liquids A and B can be mixed at different mixing ratios.

### Third embodiment

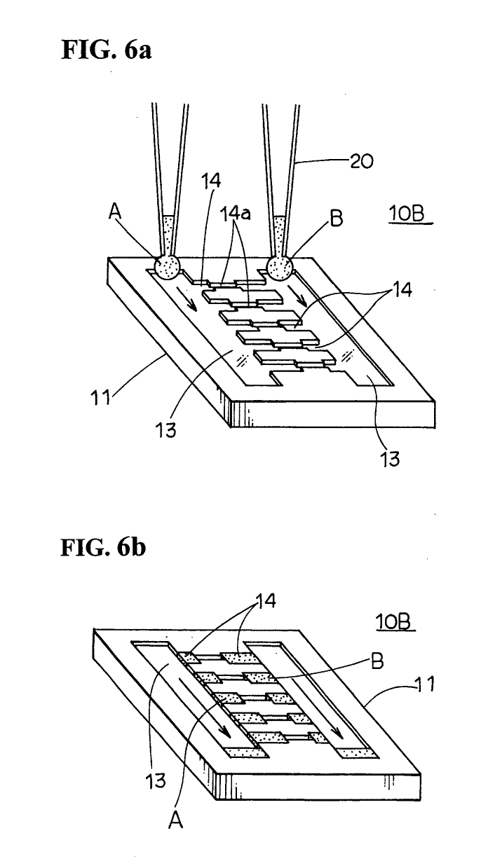

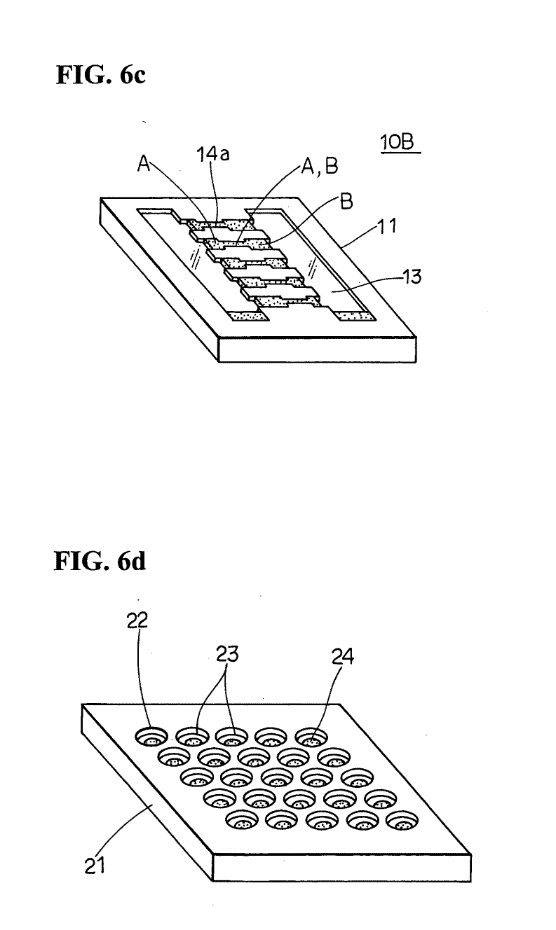

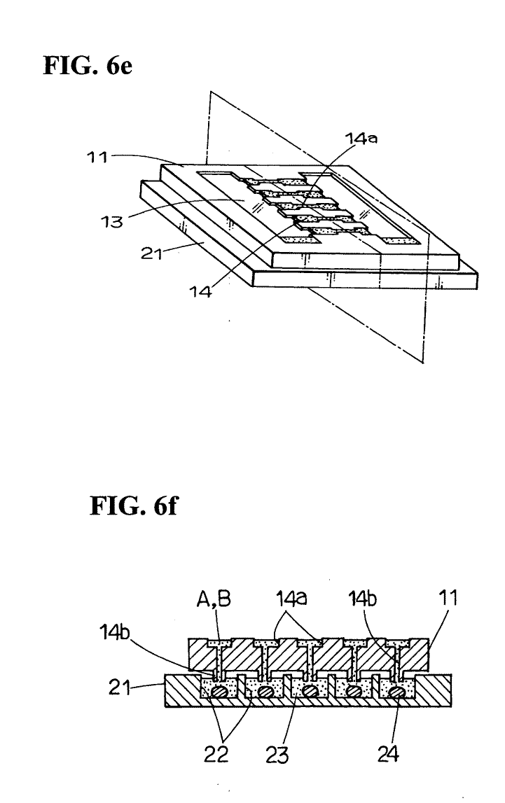

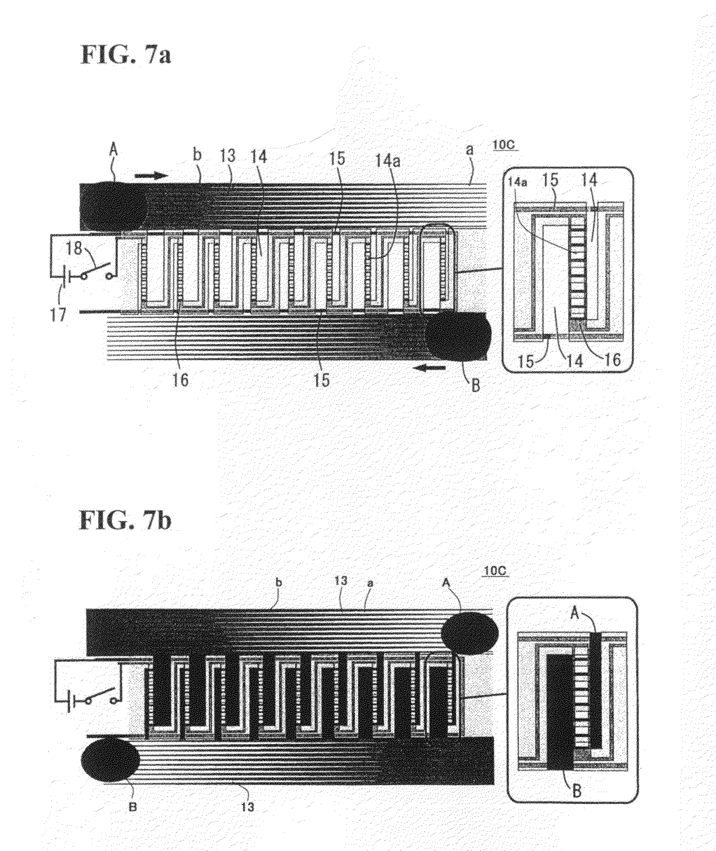

Next, a microvolume liquid dispensing device 10B according to a third embodiment of the present invention will be described with reference to FIG. 6.

As shown in FIG. 6, the microvolume liquid dispensing device 10B of the third embodiment is changed in the following points of the configuration of the microvolume liquid dispensing device 10A of the second embodiment.

They are (1) that the transporting directions of the microvolume liquids A and B in both main channels 13 are the same, (2) that the number of side channels 14 connected with each main channel 13 is five, and (3) that five nozzles 14b in total, each having one end of an opening that is connected with the side channel 14, are arranged on the intermediate portion in the longitudinal direction of respective micro side channels 14a on the substrate 11 (FIG. 6f). In one of the main channels 13, volumes of the side channels 14 become gradually smaller toward downstream while in the other main channel 13, volumes of the side channels 14 become gradually larger toward downstream. Each nozzle 14b has an inner diameter of 50 μm, and a distal end portion thereof protrudes 2 mm downward from the undersurface of the substrate 11.

Next, usage of the microvolume liquid dispensing device 10B according to the third embodiment will be described with reference to FIGS. 6a to 6f.

0.1 to 10 μL of a microvolume liquid A and a microvolume liquid B are measured by a micropipette 20 and introduced to the upstream of the two main channels 13 (FIG. 6a).

Those microvolume liquids A and B automatically travel downstream in respective main channels 13 due to a wettability gradient, and a part thereof is guided to each side channel 14 midway. The guided microvolume liquids A and B are dammed at an end of second electrodes 16 close to the outlet of corresponding side channels 14, and specific amounts of them are measured out (FIG. 6b).

Subsequently, a voltage is applied to both electrodes 15 and 16 provided in each side channel 14, so that the measured microvolume liquids A and B in respective side channels 14 get over the second electrodes 16 and travel, come in contact with each other and are mixed eventually (FIG. 6c).

On the other hand, a biopsy tray 21 formed with 5 by 5 (25 in total) cell culture wells (chambers) 22 on a top surface thereof is prepared. In each cell culture well 22, a cell 24 which is an analyte and a culture medium 23 therefor are injected (FIG. 6d).

After that, the substrate 11 is placed on the biopsy tray 21, and respective distal end portions of the nozzles 14b are immersed into the culture mediums 23 in the cell culture wells 22 (respective openings at a distal end are placed under the liquid level) in a predetermined line (row). As a result, an agent included in the liquid mixture of the microvolume liquids A and B in each micro side channel 14a located above is transported by diffusion into the culture medium 23 in the cell culture well 22 located below via each nozzle 14b. Accordingly, a biopsy of respective cells 24 can be performed with the use of the microvolume liquids A and B mixed at five different mixing ratios.

As above, the nozzle 14b is arranged at a portion of each micro side channel 14a on the substrate 11, so that a component such as an agent included in the microvolume liquids A and B within each micro side channel 14a can be extracted outside easily. Moreover, the distal end portion of each nozzle 14b is configured to protrude from the undersurface of the substrate 11 and be immersed into the culture solution 23 in the cell culture well 22. Consequently, a chemical component such as an agent included in the microvolume liquids A and B within each micro side channel 14a can automatically be transported by diffusion into a culture medium 23 in a corresponding cell culture well 22 even without using external force such as pressure, gravity and acoustic wave.

Other configurations, operation and effects are within the assumable range from the second embodiment, and thus their descriptions are omitted.

### INDUSTRIAL APPLICABILITY

The present invention can be used in the field of chemical analysis and biochemical analysis. More specifically, the present invention is applicable to compact medical analyzers, portable environmental analyzers, etc. Its effects are such that an analysis time is reduced due to rapid reaction on a microscale, thereby allowing for on-site analyses, and also that an amount of reagent and sample (test specimen) used is reduced, thereby being able to promote reduction in running costs, downsizing liquid delivery systems such as liquid delivery channels, significant reduction in waste liquid amount and resulting in mitigation of environmental contamination.

Further, the present invention can be used in the field of chemical synthesis. More specifically, the present invention is applicable to high-efficiency chemical plants, on-demand manufacturing systems, etc. Its effects are such that flow processing becomes possible due to rapid reaction on a microscale, and also that precise reaction control is possible due to high homogeneity of a temperature/concentration field, and in a case of a microreactor, a time period from development to production can be significantly reduced due to ease of design and manufacturing, thereupon being able to promote yield improvement by high-efficiency reaction.

Further, the present invention is suitable for drug discovery screening (exhaustive searching). In other words, the present invention is superior in searching an optimum concentration of one agent and searching an optimum mixing ratio of two agents (searching a new drug based on new effects).

### Fourth Embodiment

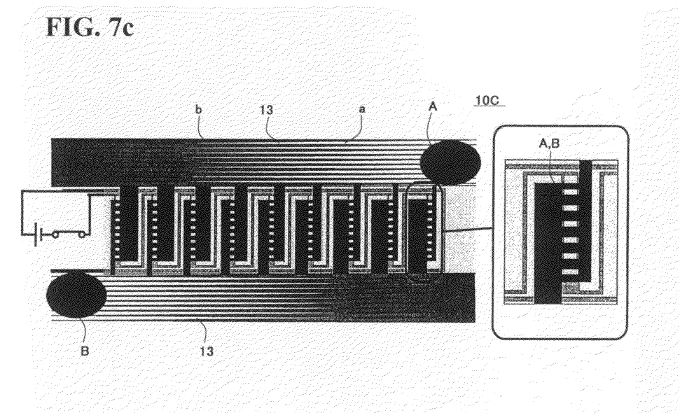

Now, a microvolume liquid dispensing device 10C according to a fourth embodiment of the present invention will be described with reference to FIG. 7.

As shown in FIG. 7, the microvolume liquid dispensing device 10C of the fourth embodiment is arranged with two main channels 13 in parallel with each other being spaced apart and is alternately arranged with respective nine side channels 14 of the main channels 13 adjacent to each other. More specifically, a side channel 14 extending from one of the main channels 13 and a side channel 14 extending from the other forms a pair, and the microvolume liquid dispensing device 10C is arranged with nine pairs of side channels. Respective side surfaces of the pair of side channels 14 are connected with each other by seven micro side channels 14a extending linearly. The first electrode 15 is arranged around an entrance of each side channel 14. The second electrode 16 is arranged at the side surface of each side channel 14 where the micro side channels 14a are connected. Different microvolume liquids A and B are transported in respective main channels 13, a portion of each microvolume liquid A, B is sampled in each side channel 14 during transportation, and then the sampled different microvolume liquids A and B are mixed by voltage application between a corresponding first electrode 15 and second electrode 16. The microvolume liquid A is an electrolytic solution containing ions while the microvolume liquid B is another electrolytic solution containing ions.

In this case, the two main channels 13 have the same shape, and the side channels 14 connected with each other between both main channels 13 all have the same total value in volume. However, the side channels 14 are configured to be different in volume ratio. More specifically, to a side channel 14 having the largest volume of one of the main channels 13, a side channel 14 having the smallest volume of the other main channel 13 is connected. Then, a side channel 14 having the second largest volume of the one main channel 13 and a side channel having the second smallest volume of the other main channel 13 are connected. In this manner, side channels 14 arranged at one of the main channel 13 and side channels 14 arranged at the other main channel 13 are connected in sequence. Thus, transporting directions of the microvolume liquids A and B in both main channels 13 are opposed.

Subsequently, usage of the microvolume liquid dispensing device 10C according to the fourth embodiment of the present invention will be described with reference to FIGS. 7a to 7c.

0.1 to 10 μL of a microvolume liquid A and a microvolume liquid B are measured by a general-purpose dispenser and introduced from the upstream of the two main channels 13, respectively. The microvolume liquids A and B automatically travel toward the downstream in the main channels 13 due to a wettability gradient, and a part thereof is guided to the side channel 14 midway. The guided liquid is dammed at an end of the second electrode 16 provided close to the outlet of the side channel 14, and specific amounts of the microvolume liquids A and B are measured out.

Subsequently, a voltage is applied to both electrodes 15 and provided in the side channel 14. Then, the measured two kinds of microvolume liquids A and B within the side channels 14 get over the second electrodes 16 and come in contact with each other, thereby being mixed. Changing the width of a plurality of side channels allows for mixing at various mixing ratios. Further, since volumes of the microvolume liquids A and B are significantly small, the mixing progresses rapidly and a time required is remarkably short.

Other configurations, actions and effects are within the assumable range from the second embodiment, and thus their descriptions are omitted.

1. A microvolume liquid dispensing device comprising:
a substrate;
a main channel formed on an upper surface of the substrate and extending linearly; and
one or a plurality of side channels branched off from midway of the main channel and extending linearly, wherein
an upper surface of the substrate constituting the main channel is composed of a hydrophilic surface and a hydrophobic surface, and a value obtained by dividing an area of the hydrophilic surface by that of the hydrophobic surface is continuously increased from upstream toward downstream thereof, thereby transporting a microvolume liquid; and
an upper surface of the substrate constituting the side channel is made hydrophilic, and a part of the microvolume liquid is guided to the side channel while the microvolume liquid is being transported in the main channel, thereby a predetermined amount of the microvolume liquid is sampled.

2. The microvolume liquid dispensing device according to claim 1, wherein
the substrate possesses electrical insulation;
the upper surface of the substrate constituting the side channel is provided with a first electrode and a second electrode in this order toward downstream thereof being spaced apart;
a surface of the second electrode is hydrophobic;
a microvolume liquid having been dammed at the second electrode having the hydrophobic surface is transported downstream of the side channel by applying a voltage between both electrodes.

3. The microvolume liquid dispensing device according to either claim 1 or claim 2, wherein
a plurality of the main channels are arranged spaced apart;
respective downstream ends of the side channels provided to the main channels adjacent to each other are connected with each other;
the second electrode is arranged at a connecting portion at the downstream end of each side channel or slightly upstream of the connecting portion of the side channel; and
different microvolume liquids are transported on respective main channels, a portion of each microvolume liquid is sampled in the corresponding side channel during transportation, and then the respective sampled different microvolume liquids are mixed by voltage application between both electrodes.

4. The microvolume liquid dispensing device according to anyone of the preceding claims, wherein one surface of the substrate is mounted with a cover.

5. The microvolume liquid dispensing device according to claim 3, wherein
a side channel extending from one of the main channels adjacent to each other and a side channel extending from the other forms a pair; and
a plurality of micro side channels extending linearly from a side surface of one of the paired side channels are provided to be connected to a side surface of the other side channel.

6. The microvolume liquid dispensing device according to claim 5, wherein a cover is mounted at least on a side channel forming portion of the substrate.
